(19) United States
(12) Patent Application Publication
(10) Pub. No.: US 2006/0044095 A1
(43) Pub. Date: Mar. 2, 2006

(54) Solenoid with improved spring-back spindle set

(75) Inventor: David Huang, Changhua County (TW)

Correspondence Address: BACON & THOMAS, PLLC, 625 SLATERS LANE, FOURTH FLOOR, ALEXANDRIA, VA, 22314, US

(73) Assignee: TRICORE CORPORATION, CHANG HUA (TW)

(21) Appl. No.: 11/208,621

(22) Filed: Aug. 23, 2005

(30) Foreign Application Priority Data
Aug. 27, 2004 (TW) 93213690

(51) Int. Cl. H01F 7/08

(52) U.S. Cl. 335/220

(57) ABSTRACT

A solenoid is disclosed to include a mount seat has a receiving housing forming a receiving room; a magnet assembly has a magnet part installed inside the receiving room of the mount seat; a spindle set has a spindle, a coil wound around the spindle and positioned inside the magnet part of magnet assembly, and a actuating against portion connected at an end of the spindle; a spring member has a spindle connect portion connected to the spindle set, a spring-back portion connected to the spindle connect portion and providing elastic deformation and spring back, and a seat connect portion connected between the spring-back portion and the receiving housing of the mount seat.

### BACKGROUND OF THE INVENTION

1. Field of the Invention

The present invention relates to solenoids and more particularly, to a solenoid with improved spring-back spindle set.

2. Description of the Related Art

A solenoid usually has a spindle set for moving and actuating, the conventional spring back structure is a compression spring for controlling the spindle set spring back to the original position.

However, the electrical products are smaller gradually, but the structure of aforesaid compression spring still occupied more space and difficult to install or un-install, and the spring back effect is poor.

### SUMMARY OF THE INVENTION

The present invention has been accomplished under the circumstances in view. It is the main object of the present invention to provide a solenoid, which allows simplifying the structure of the spring member which compact and easy to install. It is another object of the present invention to provide a solenoid, which improved on layout and spring-back for providing quickly and exactly spring-back.

To achieve these and other objects of the present invention, the solenoid comprising: a mount seat has a receiving housing forming a receiving room; a magnet assembly has a magnet part installed inside the receiving room of the mount seat; a spindle set has a spindle, a coil wound around the spindle and positioned inside the magnet part of magnet assembly, and an actuating against portion connected at an end of the spindle; a spring member has a spindle connect portion connected to the spindle set, a spring-back portion connected to the spindle connect portion and providing elastic deformation and spring back, and a seat connect portion connected between the spring-back portion and the receiving housing of the mount seat.

### BRIEF DESCRIPTION OF THE DRAWINGS

FIG. 1 is an exploded elevational view showing a solenoid according to the present invention.

FIG. 2 is an exploded plain view of the solenoid according to the present invention.

FIG. 3 is a sectional assembly view of the solenoid according to the present invention.

FIG. 4 corresponds to FIG. 3 showing the status of the movement.

FIG. 5 shows another structure of the spring member according to the present invention.

FIG. 6 shows still another structure of the spring member according to the present invention.

FIG. 7 shows still another structure of the spring member according to the present invention.

FIG. 8 shows still another structure of the spring member according to the present invention.

### DETAILED DESCRIPTION OF THE INVENTION

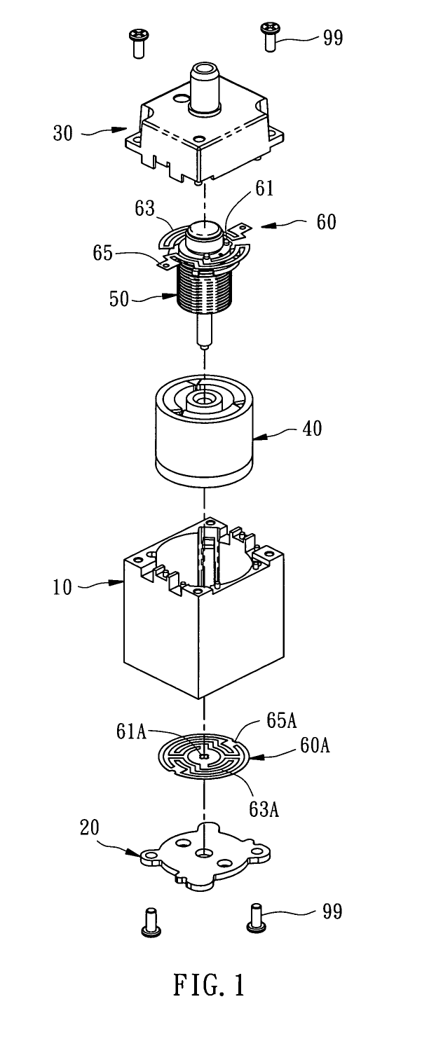

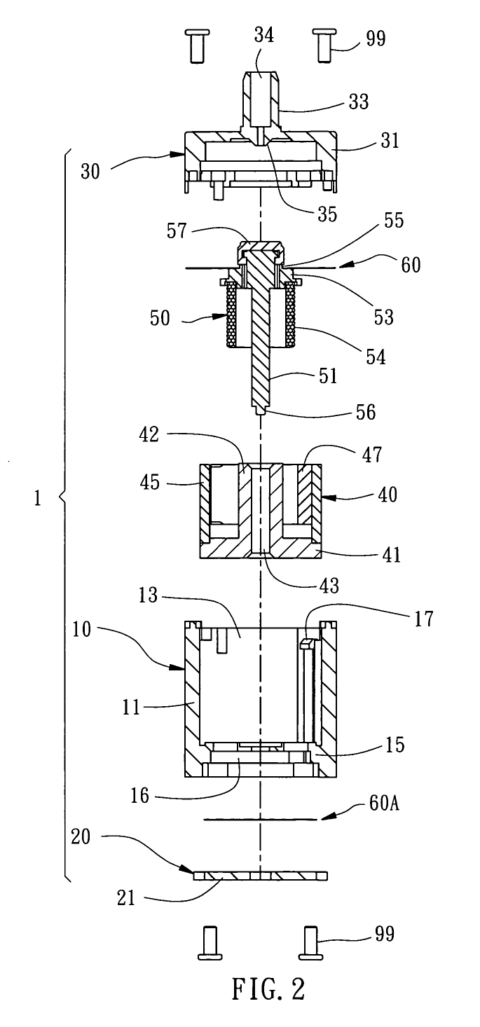

Referring to FIG. 1 to FIG. 3, a solenoid of a preferably embodiment according to the present invention comprises:

A mount seat 1 consists of a receiving housing 10, a lower case 20, and an upper cover 30.

The receiving housing 10 has a housing body 11 forming a receiving room 13, a fixation portion 15, an escape capture 16, and two locking parts 17 deformable and has a jaw at a distal end.

The lower case 20 has a case plate 21 fastened and sealed to a lower side of the receiving housing 10 by a plurality of bolts 99.

The upper cover 30 has a cover body 31 fastened and sealed to an upper side of the receiving housing 10 by a plurality of bolts 99, a connect pipe 33 with an air communication hole 34, and an actuating against portion 35.

Wherein the assembled position of the upper cover 30 and lower case 20 to the receiving housing 10 further formed a first spring fix portion 1A and a second spring fix portion 1B respectively.

A magnet assembly 40 has a barrel seat 41, a bush rod 42 with a spindle receiving hole 43 connected to the barrel seat 41, a protect barrel 45 mounted on the barrel seat 41 and received inside the receiving room 13 of the receiving housing 10, and a magnet part 47 consists of three magnets of arch shape installed inside the protect barrel 45.

A spindle set 50 has a spindle 51, a spindle head 53, a coil 54, a first spring stop portion 55 and a second spring stop portion 56 formed at each side, and a actuating against portion 57 which is a sealing cap connected to the spindle head 53.

A spring member 60 has a spindle connect portion 61 connected to the spindle head 53 of the spindle set 50, a spring-back portion 63 of zigzag plate connected to the spindle connect portion 61, and a seat connect portion 65 connected to the spring-back portion 63 and fastened to the second spring fix portion 1B of the mount seat 1.

A second spring member 60A proximately same as the spring member 60, the second spring member 60A has a spindle connect portion 61A connected to the second spring stop portion 56 of the spindle set 50, a spring-back portion 63A, and a seat connect portion 65A fastened to the first spring fix portion 1A of the mount seat 1.

The assembly of the solenoid, first install the magnet assembly 40 inside the receiving room 13 of the receiving housing 10 to form a first sub-assembly, and install the spring member 60 to the spindle head 53 of the spindle set 50, to form a second sub-assembly, then let the second sub-assembly install to the first sub-assembly, the spindle head 53 of the spindle set 50 is movable inserted inside the spindle receiving hole 43 of the magnet assembly 40, and the magnet part 47 of the magnet assembly 40 layout at outer periphery of the coil 54 of the spindle set 50.

Further, let the spindle connect portion 61A of the second spring member 60A connected to the second spring stop portion 56 of the spindle set 50 at lower end of the spindle 51, and put the upper cover 30 to covering the receiving housing 10 by threads.

The position and the actuation of the embodiment are as below:

Referring to FIG. 4, the coil 54 of the spindle set 50 is conducted electric and providing magnet power to the magnet part 47 of the magnet assembly 40, the spindle set 50 is moved to an axially end, and together with the spring member 60 and second spring member 60A, and the actuating against portion 57 of the spindle set 50 sealed the actuating against portion 35 of the upper cover 30, this embodiment is to control air releasing form the air communication hole 34 of the upper cover 30.

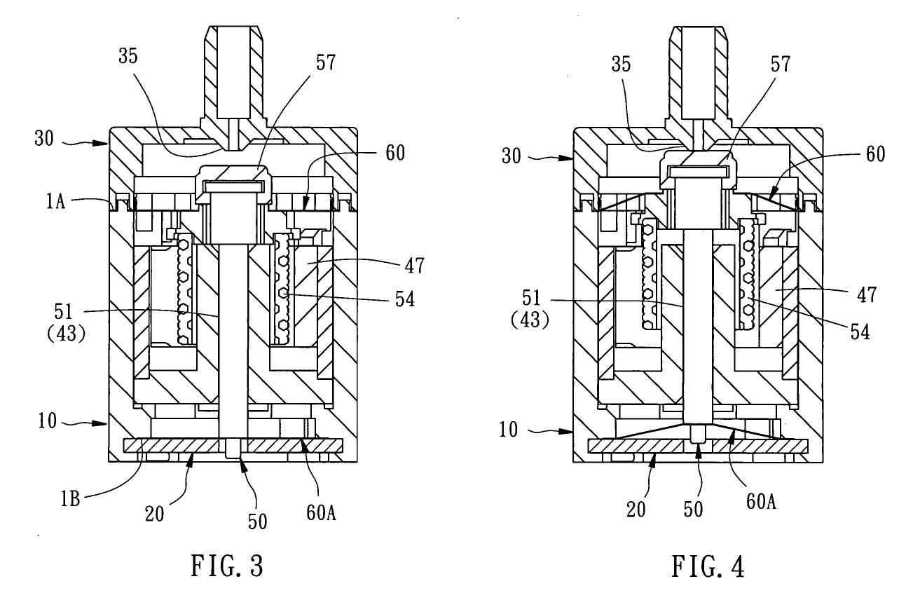

At the other end, when the coil 54 of the spindle set 50 is power off, the no magnet power, the spring member 60 and second spring member 60A then spring back by return of de-formation, and let the spindle set 50 move return the original position shown same as in FIG. 3.

Therefore, the structure of the spring member 60 and second spring member 60A compacted the solenoid of the present invention, and let the spindle set 50 returned to original position quickly and exactly.

The material of the spring member 60 and second spring member 60A is preferably beryllium cooper to providing better spring back effect.

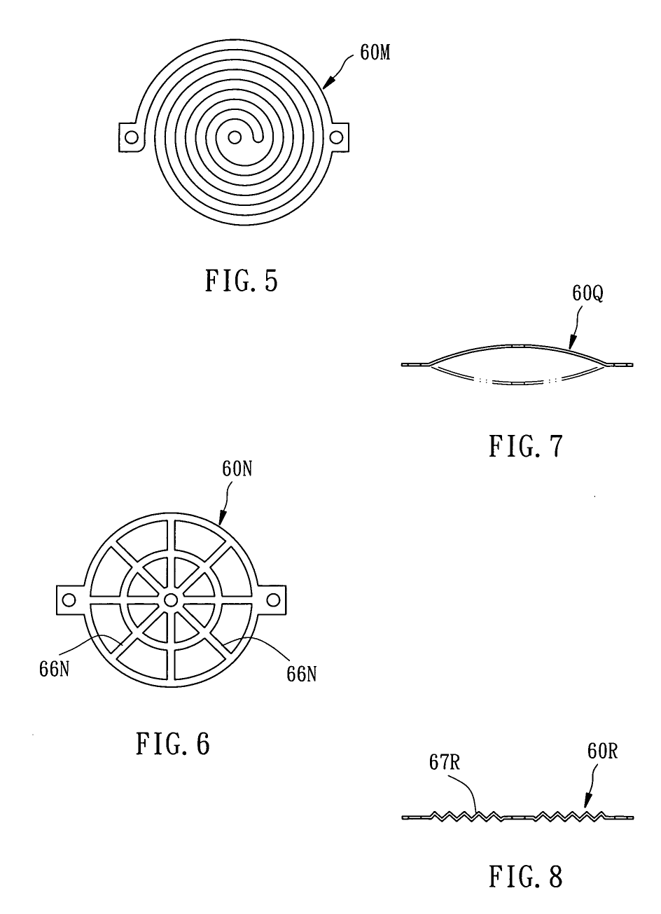

FIG. 5 shows an alternate form of the present invention, according to this embodiment, the spring member 60M is a hair spring; and FIG. 6 shows an alternate form of the present invention, according to this embodiment, the spring member 60N is a mesh connected between center and outer periphery.

Moreover, FIG. 7 shows an alternate form of the present invention, according to this embodiment, the spring member 60Q is formed of pan of arch or sphere shape; or FIG. 8 shows an alternate form of the present invention, according to this embodiment, the spring member 60R is formed of plate which has a plurality of circular grooves 67R thereon.

As indicated above, the invention provides a solenoid, which has the following advantages:
1. The solenoid allows simplifying the structure of the spring member which compact and easy to install.
2. The solenoid improved on layout and spring-back for providing quickly and exactly spring-back.

What is claimed is:

1. A solenoid comprising:
a mount seat having a receiving housing forming a receiving room;
a magnet assembly having a magnet part installed inside said receiving room of said mount seat;
a spindle set having a spindle, a coil wound around said spindle and positioned inside said magnet part of magnet assembly, and an actuating against portion connected at an end of said spindle;
a spring member having a spindle connect portion connected to said spindle set, a spring-back portion connected to said spindle connect portion and providing elastic deformation and spring back, and a seat connect portion connected between said spring-back portion and said receiving housing of said mount seat.

2. The solenoid as claimed in claim 1, wherein said mount seat further has a lower case.

3. The solenoid as claimed in claim 1, wherein said mount seat further has an upper cover.

4. The solenoid as claimed in claim 1, wherein said mount seat further has a connect pipe with an air communication hole.

5. The solenoid as claimed in claim 1, wherein said mount seat further has an actuating against portion, said actuating against portion of said spindle set is a sealing cap.

6. The solenoid as claimed in claim 1, wherein said spring-back portion of said spring member is selected from the group of plate, hair spring, pan and mesh.

7. The solenoid as claimed in claim 1, further comprises a second spring member being connected between said spindle of said spindle set and said mount seat.

8. The solenoid as claimed in claim 1, further comprises a barrel seat having a spindle receiving hole providing insertion of said spindle of said spindle set.

9. The solenoid as claimed in claim 1, wherein said magnet assembly further has a protect barrel received inside said receiving room of said mount seat.

10. The solenoid as claimed in claim 1, wherein said magnet part of said magnet assembly consists of at least two magnets of arch shape.
